(19) United States
(12) Patent Application Publication
(10) Pub. No.: US 2025/0239251 A1
(43) Pub. Date: Jul. 24, 2025

(54) SOUND CONTROLLER AND SOUND GENERATION METHOD

(71) Applicant: HONDA MOTOR CO., LTD., TOKYO (JP)

(72) Inventors: Yuma KAEDE, TOKYO (JP); Takanori NIIKURA, TOKYO (JP)

(21) Appl. No.: 19/033,703

(22) Filed: Jan. 22, 2025

(30) Foreign Application Priority Data
Jan. 23, 2024 (JP) 2024-008177

(51) Int. Cl. G10K 15/02; B60Q 9/00; H04R 3/00

(52) U.S. Cl. CPC G10K 15/02; H04R 3/00; B60Q 9/00; H04R 2430/01; H04R 2499/13

(57) ABSTRACT

A sound controller is a sound controller that causes a speaker to output sound into a cabin of a vehicle, and has a signal generation unit that generates a sound signal causing the speaker to output sound, an acquisition unit that acquires an operation value according to an operation by a user, a gain determination unit that determines a gain of the sound signal according to the operation value, and an output unit that outputs to the speaker the sound signal corrected to the gain. The gain determination unit determines, when the operation value is smaller than a predetermined reference value, the gain to be smaller as the difference between the reference value and the operation value increases, and determines, when the operation value is larger than the reference value, the gain to be larger as the difference between the reference value and the operation value increases.

### CROSS-REFERENCE TO RELATED APPLICATIONS

This application is based upon and claims the benefit of priority from Japanese Patent Application No. 2024-008177 filed on Jan. 23, 2024, the contents of which are incorporated herein by reference.

### BACKGROUND OF THE INVENTION

### Field of the Invention

The present disclosure relates to a sound controller and a sound generation method.

### Description of the Related Art

JP 2022-020160 A discloses a sound controller with which a driver can set the volume of an alarm given by an alarm device.

### SUMMARY OF THE INVENTION

A better sound controller and a better sound generation method are long-awaited.

An object of the present invention is to solve the aforementioned problem.

A first aspect of the present disclosure is a sound controller for causing a speaker to output a sound into a cabin of a vehicle includes a signal generation unit that generates a sound signal that is a signal that causes the speaker to output the sound, an acquisition unit that acquires an operation value according to an operation by a user, a gain determination unit that determines a gain of the sound signal according to the operation value acquired by the acquisition unit, and an output unit that outputs to the speaker the sound signal corrected to the gain determined by the gain determination unit, wherein the gain determination unit determines, in a case where the operation value is smaller than a predetermined reference value, the gain to be smaller as the difference between the reference value and the operation value becomes larger, and determines, in a case where the operation value is larger than the reference value, the gain to be larger as the difference between the reference value and the operation value becomes larger.

A second aspect of the present disclosure is a sound generation method for causing a speaker to output a sound in a cabin of a vehicle includes: generating a sound signal as a signal that causes the speaker to output the sound; acquiring an operation value corresponding to an operation performed by a user; determining, in a case where the acquired operation value is smaller than a predetermined reference value, a gain to be smaller as a difference between the reference value and the operation value becomes larger, and determining, in a case where the operation value is larger than the acquired reference value, the gain to be larger as the difference between the reference value and the operation value becomes larger; and outputting to the speaker the sound signal corrected to the determined gain.

According to the present invention, a better sound controller and a better sound generation method can be provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a block diagram showing the configuration of a sound controller according to an embodiment;

FIG. 2 is a diagram showing a display unit on which an operation element is displayed according to one embodiment;

FIG. 3 is a map of a gain of one embodiment;

FIG. 4 is a flowchart of a sound effect generation process executed in the sound controller in one embodiment;

FIG. 5 is a diagram showing a display unit on which an operation element is displayed according to a comparative example;

FIG. 6 is a map of a gain of the comparative example;

FIG. 7 is a diagram showing a display unit on which an operation element is displayed according to another embodiment; and

FIG. 8 is a diagram showing a display unit on which a volume input unit is displayed according to another embodiment.

### DETAILED DESCRIPTION OF THE INVENTION

In the case of a conventional sound controller (active sound effect generation device), a user cannot set the sound pressure (volume) of a sound effect. According to a sound controller of the present invention, a user can set the sound pressure of a sound effect, as will be described later. In addition, according to the sound controller of the present invention, it is possible to favorably reflect the design concept on the volume of the sound effect and the like adjusted by the user, as will be described later.

### One Embodiment

### [Configuration of Sound Controller]

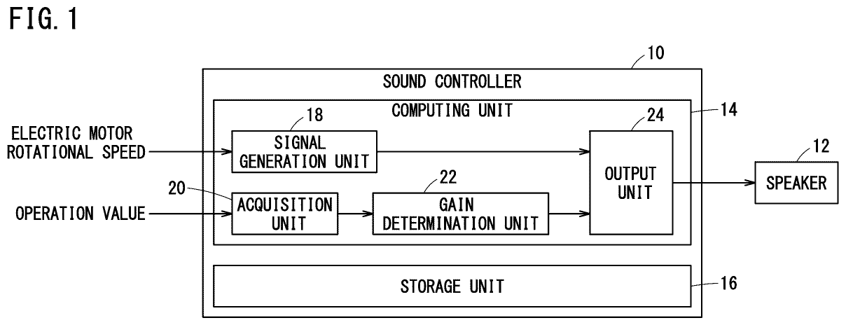

FIG. 1 is a block diagram showing the configuration of a sound controller 10 according to an embodiment. The sound controller 10 is, for example, an active sound effect generation device. The sound controller 10 is installed in a vehicle having an electric motor as a driving source. Vehicles driven by the electric motor are BEVs (Battery Electric Vehicles), HEVs (Hybrid Electric Vehicles), PHEVs (plug-in Hybrid Electric Vehicles), FCEVs (Fuel Cell Electric Vehicles), etc. The sound controller 10 may be installed in a vehicle having an internal combustion engine as a driving source.

The sound controller 10 is a device that outputs a sound effect that changes according to the rotational speed of an electric motor, from a speaker 12 provided in a cabin of a vehicle. The sound effect enhances the attractiveness of a car to occupants. The sound controller 10 may output a sound effect that varies according to the vehicle speed, from the speaker 12 provided in the cabin. When the sound controller 10 is installed in a vehicle having an internal combustion engine as a driving source, the sound controller 10 may output a sound effect that varies according to the rotational speed of the internal combustion engine, from the speaker 12 provided in the cabin.

The sound controller 10 includes a computing unit 14 and a storage unit 16. The computing unit 14 is a processor such as a CPU (Central Processing Unit), a GPU (Graphics Processing Unit), or the like.

The computing unit 14 functions as a signal generation unit 18, an acquisition unit 20, a gain determination unit 22, and an output unit 24. The signal generation unit 18, the acquisition unit 20, the gain determination unit 22, and the output unit 24 are realized by the computing unit 14 executing programs stored in the storage unit 16.

At least part of the signal generation unit 18, the acquisition unit 20, the gain determination unit 22, and the output unit 24 may be realized by an integrated circuit such as an ASIC (Application Specific Integrated Circuit), an FPGA (Field-Programmable Gate Array), or the like. At least part of the signal generation unit 18, the acquisition unit 20, the gain determination unit 22 and the output unit 24 may be realized by an electronic circuit including a discrete device.

The storage unit 16 is composed of a volatile memory (not shown) and a non-volatile memory (not shown), which are computer-readable storage media. The volatile memory is, for example, RAM (Random Access Memory) or the like. The nonvolatile memory is, for example, ROM (Read Only Memory), flash memory, or the like. Data or the like are stored, for example, in volatile memory. Programs, tables, maps, or the like are stored, for example, in non-volatile memory.

At least part of the storage unit 16 may be provided in the above-mentioned processor, integrated circuit, or the like. At least part of the storage unit 16 may be installed in a device connected to the sound controller 10 through a network.

The signal generation unit 18 generates a sound effect signal. The sound effect signal is a signal of a sound effect having a frequency component according to the rotational speed of the electric motor.

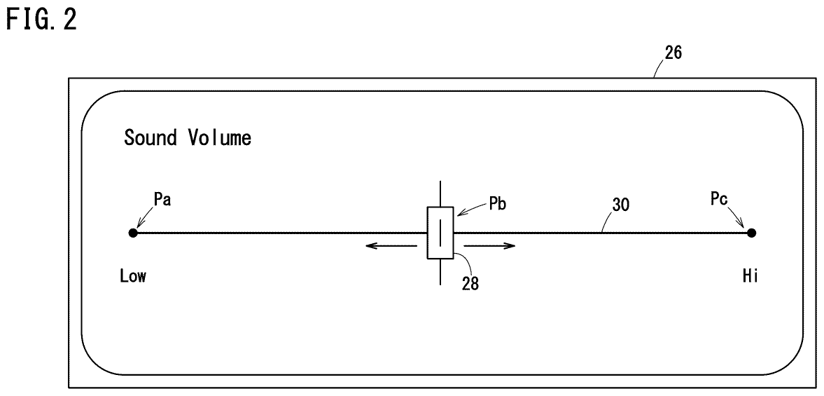

The acquisition unit 20 acquires an operation value according to an operation by a user. The operation value is determined by the user operating an operation element 28 displayed on a display unit 26 (FIG. 2).

FIG. 2 is a diagram showing the display unit 26 on which the operation element 28 are displayed according to one embodiment. The display unit 26 is installed in a central portion of an instrument panel in the cabin. As shown in FIG. 2, the display unit 26 displays the operation element 28 and a slide bar 30. The operation element 28 is a slider that can be moved along the slide bar 30 by a user operation.

The operation values of “0” to “255” are input to the sound controller 10 according to the position of the operation element 28 on the slide bar 30. When the operation element 28 is located at a left end position Pa of the slide bar 30, the operation value “0” is input to the sound controller 10. When the operation element 28 is located at a center position Pb of the slide bar 30, the operation value “128” is input to the sound controller 10. When the operation element 28 is located at a right end position Pc of the slide bar 30, the operation value “255” is input to the sound controller 10. The correspondence between the positions of the operation element 28 and the operation values is not limited to the above example.

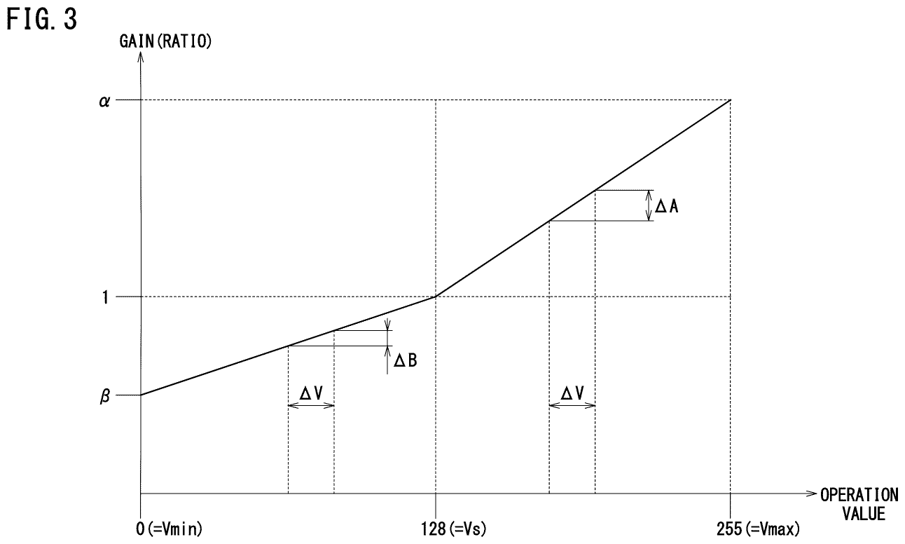

The gain determination unit 22 determines the gain of the sound effect signal according to the operation value acquired by the acquisition unit 20. FIG. 3 is a map of a gain of one embodiment. The gain determination unit 22 determines the gain according to the map of FIG. 3.

In one embodiment, “128” is predetermined as a reference value. When the operation value matches the reference value, the gain determination unit 22 determines the gain to be “1”. When the operation value is smaller than the reference value, the gain determination unit 22 determines the gain to be a value smaller than “1”. When the operation value is smaller than the reference value, the gain determination unit 22 determines the gain to be a value that becomes smaller as the difference between the reference value and the operation value increases. When the operation value is larger than the reference value, the gain determination unit 22 determines the gain to be a value larger than “1”. When the operation value is larger than the reference value, the gain determination unit 22 determines the gain to be a value that becomes larger as the difference between the gain reference value and the operation value increases.

As shown in FIG. 3, the amount of change AB in the gain when the operation value is changed by a predetermined amount ΔV when the operation value is smaller than the reference value is smaller than the amount of change AA in the gain when the operation value is changed by the predetermined amount ΔV when the operation value is larger than the reference value.

The gain determination unit 22 may determine the gain by calculation without using a map. When the operation value is larger than the reference value, a gain G can be obtained by the following formula (1) using a positive constant α (α>1), where G denotes the gain, Vo denotes the operation value, and Vmax denotes the maximum value of the operation value.

$$G = 1 + \{ ( Vo - Vs ) / ( V max - Vs ) \} \times ( α - 1 ) \qquad ( 1 )$$

When the operation value is smaller than the reference value, the gain G is obtained by the following formula (2) using a positive constant β (<1), where G denotes the gain, Vo denotes the operation value, and Vmin denotes the minimum value of the operation value.

$$G = 1 + \{ ( Vs - Vo ) / ( Vs - V min ) \} \times ( 1 - β ) \qquad ( 2 )$$

The constant α and the constant β have the following relationship of inequality (3).

$$α - 1 > 1 - β \qquad ( 3 )$$

The output unit 24 corrects the sound effect signal generated by the signal generation unit 18 to the gain determined by the gain determination unit 22. The output unit 24 outputs the corrected sound effect signal to the speaker 12. The speaker 12 generates a sound effect in the cabin in accordance with the sound effect signal.

In one embodiment, a designer of the sound controller 10 adjusts the constant α and the constant β, whereby the design concept can be well reflected on the volume of the sound effect adjusted by the user. For example, when the user performs an operation for increasing the volume on the operation element 28, the gain is further increased to increase the volume of the sound effect output to the cabin. This can further give the user a sense of exaltation and acceleration due to the sound effect. On the other hand, when the user performs an operation for reducing the volume on the operation element 28, the volume of the sound effect output to the cabin is prevented from becoming too low by suppressing the decrease in the gain. Thus, the user continues to be given a sense of exaltation and acceleration by the sound effect.

### [Sound Effect Generation Process]

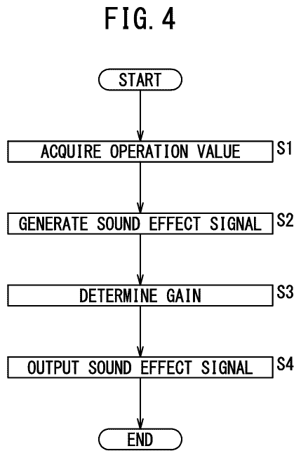

FIG. 4 is a flowchart of a sound effect generation process executed in the sound controller 10 in one embodiment. The sound effect generation process is repeatedly executed at a predetermined cycle while the electric vehicle is traveling.

In step S1, the acquisition unit 20 acquires the operation value. Then, the process proceeds to step S2.

In step S2, the signal generation unit 18 generates the sound effect signal. Then, the process proceeds to step S3.

In step S3, the gain determination unit 22 determines the gain. Then, the process proceeds to step S4.

In step S4, the output unit 24 corrects the sound effect signal generated by the signal generation unit 18 to the gain determined by the gain determination unit 22. The output unit 24 outputs the corrected sound effect signal to the speaker 12. Then, the sound effect generation process is terminated.

### Comparative Example

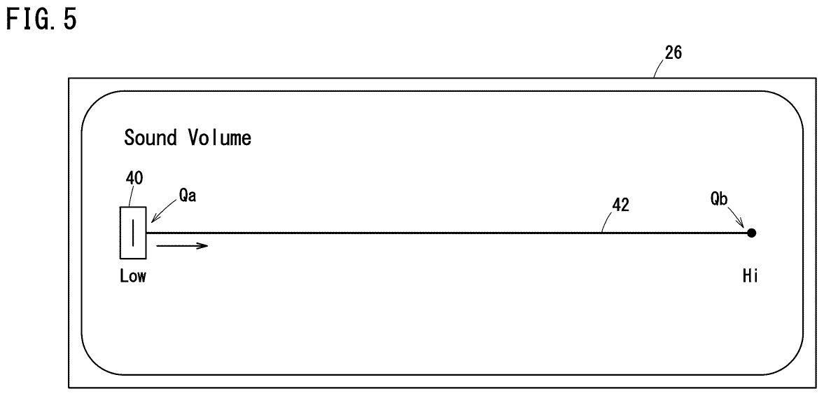

FIG. 5 is a diagram showing the display unit 26 on which an operation element 40 are displayed according to a comparative example. As shown in FIG. 5, a slide bar 42 and the operation element 40 are displayed on the display unit 26. The operation element 40 is a slider that can be moved along the slide bar 42 by a user operation.

The operation values of “0” to “255” are input to the sound controller 10 according to the position of the operation element 40 on the slide bar 42. When the operation element 40 is located at a left end position Qa of the slide bar 42, the operation value “0” is input to the sound controller 10. When the operation element 40 is located at a right end position Qb of the slide bar 30, the operation value “255” is input to the sound controller 10.

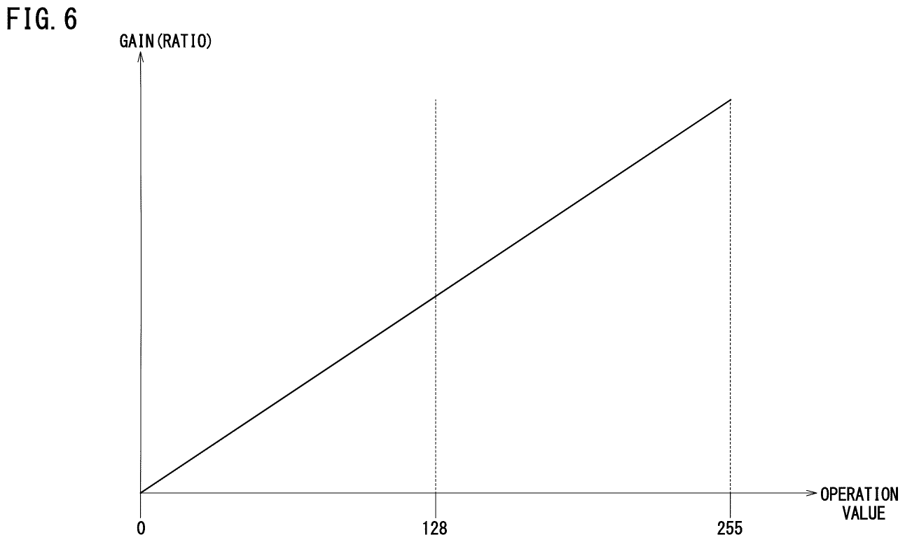

FIG. 6 is a map of a gain of the comparative example. In the comparative example, “0” is the reference value. The larger the difference between the reference value and the manipulated value is, the larger the gain becomes. As shown in FIG. 6, over the entire range of the operation value, the amount of change in the gain is constant when the operation value changes by a predetermined amount.

That is, while “128” is determined as the reference value in one embodiment, “0” is determined as the reference value in the comparative example.

In one embodiment, when the operation value is smaller than the reference value, the gain is determined to be a smaller value as the difference between the reference value and the operation value increases, and when the operation value is larger than the reference value, the gain is determined to be a larger value as the difference between the reference value and the operation value increases. In contrast, in the comparative example, there is no operation value smaller than the reference value, and the gain is determined to be a larger value as the difference between the reference value and the operation value increases.

Furthermore, in one embodiment, the amount of change in the gain when the operation value changes by a predetermined amount when the operation value is smaller than the reference value is smaller than the amount of change in the gain when the operation value changes by a predetermined amount when the operation value is larger than the reference value. In contrast, in the comparative example, the amount of change in the gain is constant when the operation value changes by a predetermined amount over the entire range of the operation value.

### OTHER EMBODIMENTS

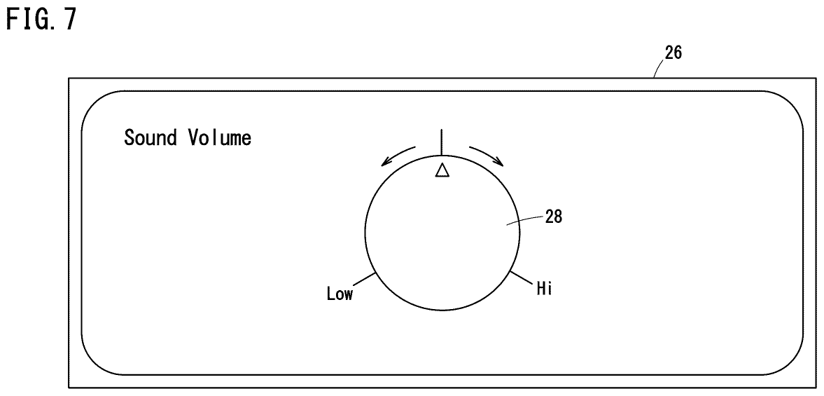

FIG. 7 is a diagram showing the display unit 26 on which the operation element 28 according to another embodiment is displayed. In the above embodiment, as shown in FIG. 2, the operation element 28 is a slider that can move on the slide bar 30. In contrast, as shown in FIG. 7, the operation element 28 may be a rotatable dial.

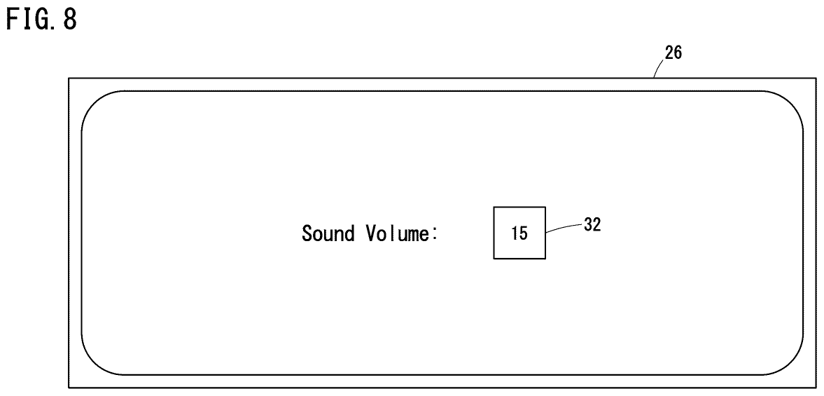

FIG. 8 is a diagram showing the display unit 26 on which a volume input unit 32 according to another embodiment is displayed. In the above one embodiment, the operation values are input to the sound controller 10 by the user operating the operation elements 28 displayed on the display unit 26. In contrast, the user may input a numerical value to the volume input unit 32 shown in FIG. 8. The numerical values input to the volume input unit 32 and the operation values are associated in advance, and the operation value corresponding to the numerical value input by the user is input to the sound controller 10.

In the above one embodiment, the signal generation unit 18 generates a sound effect signal. The signal generation unit 18 may generate a sound signal that is a signal that causes the speaker 12 to output a sound other than the sound effect.

When the signal generation unit 18 generates a sound signal, the gain determination unit 22 determines the gain of the sound signal. When the signal generation unit 18 generates a sound signal, the output unit 24 outputs to the speaker the sound signal corrected to the gain determined by the gain determination unit 22.

With respect to the above embodiments, the following supplementary notes are further disclosed.

### Supplementary Note 1

Δn sound controller (10) for causing a speaker (12) to output a sound into a cabin of a vehicle includes a signal generation unit (18) that generates a sound signal that is a signal that causes the speaker to output the sound, an acquisition unit (20) that acquires an operation value according to an operation by a user, a gain determination unit (22) that determines a gain of the sound signal according to the operation value acquired by the acquisition unit, and an output unit (24) that outputs to the speaker the sound signal corrected to the gain determined by the gain determination unit, wherein the gain determination unit determines, when the operation value is smaller than a predetermined reference value, the gain to be smaller as the difference between the reference value and the operation value becomes larger, and determines, when the operation value is larger than the reference value, the gain to be larger as the difference between the reference value and the operation value becomes larger. Thus, the gain can be set based on the difference between the reference value and the operation value.

### Supplementary Note 2

In the sound controller according to Supplementary note 1, the amount of change in the gain when the operation value changes by a predetermined amount in a case where the operation value is smaller than the reference value may be different from the amount of change in the gain when the operation value changes by the predetermined amount in a case where the operation value is larger than the reference value. Thus, the design concept can be well reflected to the gain that changes according to the user's operation.

### Supplementary Note 3

In the sound controller according to Supplementary note 2, the amount of change in the gain when the operation value changes by the predetermined amount in a case where the operation value is smaller than the reference value may be smaller than the amount of change in the gain when the operation value changes by the predetermined amount in a case where the operation value is larger than the reference value. When the user performs an operation to increase the volume, the gain can be increased to output a larger sound into the cabin. On the other hand, when the user performs an operation to reduce the volume, the decrease in the gain is suppressed so that the sound in the cabin does not become too low.

### Supplementary Note 4

In the sound controller according to any one of Supplementary notes 1-3, the operation value may be determined by the user operating an operation element (28) displayed on a display unit (26) provided on an instrument panel in the cabin. This makes it easier for the user to operate the operation element.

### Supplementary Note 5

In the sound controller according to any one of Supplementary notes 1-3, the sound signal may be a sound effect signal that causes the speaker to output a sound effect that changes according to a rotational speed of a driving source of the vehicle. Thus, the user can adjust the volume of the sound effect.

### Supplementary Note 6

A sound generation method of the present disclosure is a sound generation method for causing a speaker to output a sound in a cabin of a vehicle, comprising: generating a sound signal as a signal that causes the speaker to output the sound; acquiring an operation value corresponding to an operation performed by a user; determining, in a case where the acquired operation value is smaller than a predetermined reference value, a gain to be smaller as a difference between the reference value and the operation value becomes larger, and determining, in a case where the operation value is larger than the acquired reference value, the gain to be larger as the difference between the reference value and the operation value becomes larger; and outputting to the speaker the sound signal corrected to the determined gain. Thus, the gain can be set based on the difference between the reference value and the operation value.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiment, the order of the operations and the order of the processes are shown as an example, and are not limited to these. The same applies to the case where numerical values or mathematical expressions are used in the description of the above-described embodiment.

1. A sound controller for causing a speaker to output a sound into a cabin of a vehicle, the sound controller comprising
one or more processors that execute computer-executable instructions stored in a memory,
wherein the one or more processors execute the computer-executable instructions to cause the sound controller to:
generate a sound signal that causes the speaker to output the sound;
acquire an operation value corresponding to an operation performed by a user;
determine, in a case where the acquired operation value is smaller than a predetermined reference value, a gain to be smaller as a difference between the reference value and the operation value becomes larger, and determine, in a case where the acquired operation value is larger than the reference value, the gain to be larger as the difference between the reference value and the operation value becomes larger; and
output to the speaker the sound signal corrected to the determined gain.

2. The sound controller according to claim 1, wherein
an amount of change in the gain when the operation value changes by a predetermined amount in a case where the operation value is smaller than the reference value is different from the amount of change in the gain when the operation value changes by the predetermined amount in a case where the operation value is larger than the reference value.

3. The sound controller according to claim 2, wherein
the amount of change in the gain when the operation value changes by the predetermined amount in a case where the operation value is smaller than the reference value is smaller than the amount of change in the gain when the operation value changes by the predetermined amount in a case where the operation value is larger than the reference value.

4. The sound controller according to claim 1, wherein
the operation value is determined by the user operating an operation element displayed on a display unit provided on an instrument panel in the cabin.

5. The sound controller according to claim 1, wherein
the sound signal is a sound effect signal that causes the speaker to output a sound effect that changes according to a rotational speed of a driving source of the vehicle.

6. A sound generation method for causing a speaker to output a sound into a cabin of a vehicle, the sound generation method comprising:
generating a sound signal that causes the speaker to output the sound;
acquiring an operation value corresponding to an operation performed by a user;
determining, in a case where the acquired operation value is smaller than a predetermined reference value, a gain to be smaller as a difference between the reference value and the operation value becomes larger, and determining, in a case where the operation value is larger than the reference value, the gain to be larger as the difference between the reference value and the operation value becomes larger; and
outputting to the speaker the sound signal corrected to the determined gain.
